(19) United States
(12) Patent Application Publication
(10) Pub. No.: US 2007/0200917 A1
(43) Pub. Date: Aug. 30, 2007

(54) METHODS AND SYSTEMS FOR IMAGE TRANSMISSION

(75) Inventors: Chia Jung Chen, Taipei Hsien (TW); Hagihara Tadanori, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MediaTek Inc., Hsin-Chu (TW)

(21) Appl. No.: 11/673,608

(22) Filed: Feb. 12, 2007

Related U.S. Application Data
(60) Provisional application No. 60/776,989, filed on Feb. 27, 2006.

(51) Int. Cl. H04N 7/14

(52) U.S. Cl. 348/14.01

(57) ABSTRACT

An embodiment of a method for image transmission performed by a mobile electronic device is provided. The mobile electronic device sequentially transmits a plurality of live images captured by a camera module thereof to a computer host for further transmitting the live images to a remote electronic device. The method for image transmission comprises the following steps. An incoming call request is received from a remote mobile electronic device. Transmission of the live images is suspended after receiving the incoming call request. At least one in-call image indicating the reception of the incoming call request is transmitted to the computer host for further transmitting the at least one in-call image to the remote electronic device.

### BACKGROUND

The invention relates to webcam functions, and more particularly, to methods and systems for image transmission.

FIG. 1 is a diagram of a personal computer 11 equipped with a conventional webcam 13. The webcam 13 (also called a web camera) is an isolated video camera used to capture and transmit periodic images or continuous frames to the personal computer 11, and subsequently the personal computer 11 transmits images or frames to a remote computer for display via Internet. Webcam software resident on the personal computer 11 typically captures the images as JPEG or MPEG files and uploads them to the Web server.

Recently, there are thousands of webcams that provide views into homes and offices. As webcam capabilities have been added to instant messaging services such as Yahoo Messenger, AOL Instant Messenger (AIM) and MSN Messenger, the live video communication over the Internet, which may be one-to-one, one-to-multiple, or multiple-to-multiple live video communication, has now reached millions of mainstream PC users worldwide. Internet users, however, must purchase webcams to provide images.

An embodiment of a method for image transmission performed by a mobile electronic device is provided. The mobile electronic device sequentially transmits a plurality of live images captured by a camera module thereof to a computer host for further transmitting the live images to a remote electronic device. An embodiment of the method for image transmission comprises the following steps. An incoming call request is received from a remote mobile electronic device. Transmission of the live images is suspended after receiving the incoming call request. At least one in-call image indicating the reception of the incoming call request is transmitted to the computer host for further transmitting the at least one in-call image to the remote electronic device.

An embodiment of a system for image transmission, installed in a mobile electronic device, comprises a transceiver module, a connection module and a MCU. The mobile electronic device sequentially transmits a plurality of live images to a computer host for further transmitting the live images to a remote electronic device. The connection module couples to the computer host. The micro-control unit (MCU) receives an incoming call request from a remote mobile electronic device via the transceiver module, suspends transmission of the live images after receiving the incoming call request, and transmits at least one in-call image indicating the reception of the incoming call request via the connection module to the computer host for further transmitting the at least one in-call image to the remote electronic device.

### BRIEF DESCRIPTION OF THE DRAWINGS

The invention can be more fully understood by reading the subsequent detailed description and examples with references made to the accompanying drawings, wherein:

FIG. 1 is a diagram of a personal computer equipped with the conventional webcam;

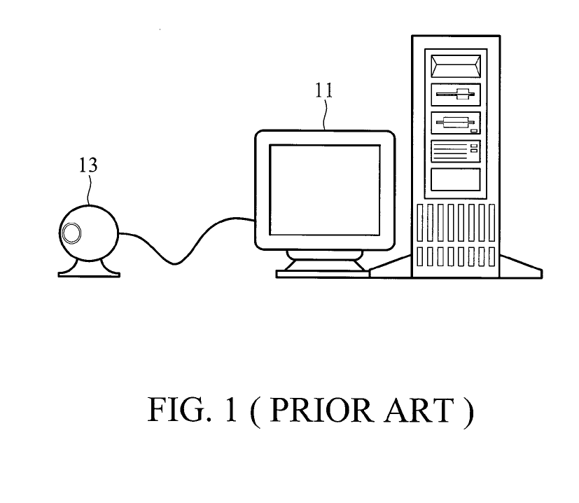

FIG. 2 is a diagram of an embodiment of a system comprising a computer host equipped with a mobile electronic device;

FIG. 3 is a diagram of the hardware architecture of an embodiment of a mobile phone;

FIG. 4 is a diagram of a hardware environment applicable to an embodiment of a computer host;

FIG. 5 is a diagram of the software architecture of an embodiment of program modules executed by a processing unit;

FIG. 6 is a diagram of data communication between two parties through an Internet protocol (IP) network;

FIG. 7 is a diagram of data communication among three parties through an IP network and a cellular network;

FIG. 8 is a sequence diagram showing suspension of transmission of live images captured by a camera module and transmission of an in-call image acquired by a storage module;

FIG. 9 is a diagram of an embodiment of a man-machine interface (MMI);

FIG. 10 is a diagram of an embodiment of an in-call image;

FIG. 11 is a flowchart of an embodiment of a method for transmitting images to the computer host when an incoming call request is received;

FIG. 12 is a diagram of a sequence diagram for resuming the suspended transmissions of live images captured by a camera module;

FIG. 13 is a flowchart of an embodiment of a method for transmitting images to a computer host when a termination signal is received;

FIG. 14a is a diagram of an embodiment of a pipeline for transmitting in-call images from a mobile electronic device to a computer host;

FIG. 14b is a diagram of an embodiment of a pipeline for transmitting live images from a mobile electronic device to a computer host.

### DETAILED DESCRIPTION

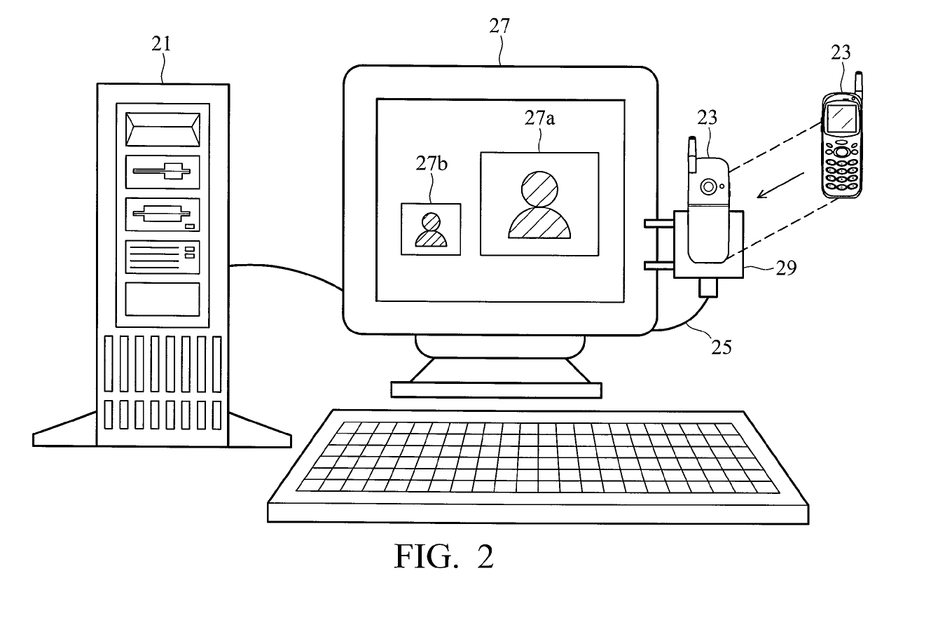

FIG. 2 is a diagram of an embodiment of a system comprising a computer host 21 equipped with a mobile electronic device 23 such as a mobile phone, smart phone or similar, providing webcam functions. A base 29 is provided to support the mobile electronic device 23 and enable easy placement in a relevant place to facilitate focusing on and capturing images of a user. The base 29 and mobile electronic device 23 may provide various connection ports such as serial ports and parallel ports, for connection therebetween via wires 25. A serial port, such as a RS232, RS242, Serial ATA (SATA), Universal Serial Bus (USB), IEEE 1394 port or similar, is an interface on a computer system by which information is transferred in or out one bit at a time. A parallel port, such as an Integrated Drive Electronics (IDE), Small Computer System Interface (SCSI), IEEE 1284 port or similar, is an interface on a computer system where data is transferred in or out in parallel, that is, on more than one wire. A parallel port carries one bit on each wire thus multiplying the transfer rate obtainable over a single cable (contrast serial port). There are usually several extra wires on the parallel port that are used for control signals to indicate when data is ready to be sent or received. Those skilled in the art will realize that the base 29 and mobile electronic device 23 may provide wireless transmitters and receivers compatible with 802.x, Bluetooth, IrDA (Infrared Data Association) or similar, for connection therebetween. Webcam software executed by the computer host 21 may provide two windows 27a and 27b for live image display, the window 27a displaying images showing a remote user, and the window 27b displaying images showing a user captured by the mobile electronic device 23. The windows 27a and 27b may be handled by a peer-to-peer (P2P) communication application such as Microsoft MSN Messenger, Yahoo! Messenger, Skype or similar to interact with a corresponding P2P communication application resident on a remote computer host. Moreover, those skilled in the art will understand that some embodiments of the computer host 21 may be practiced with other computer system configurations, including handheld devices, multiprocessor-based, microprocessor-based or programmable consumer electronics, notebooks and the like.

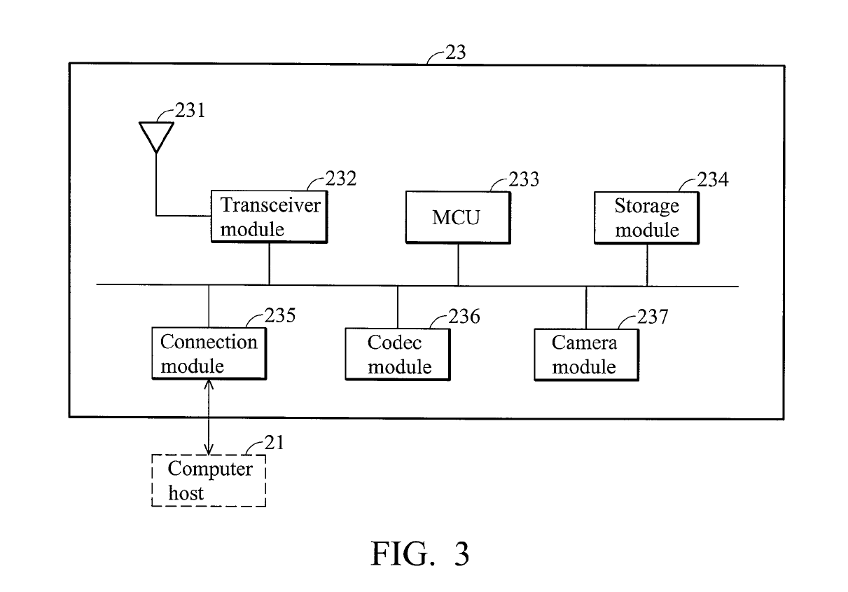

FIG. 3 is a diagram of the hardware architecture of an embodiment of the mobile phone 23 comprising an antenna 231, a transceiver module 232, a micro-processing unit (MCU) 233, a storage module 234, a connection module 235, a coder-decoder (codec) module 236 and a camera module 237. The MCU 233 is connected by buses to the transceiver 232, storage module 234, connection module 235, codec module 236 and camera module 237. The camera module 237 comprises an image sensor module and an image signal processor (ISP). The image sensor module may contain multiple charge coupled device (CCD) image sensors, complementary metal oxide semiconductor (CMOS) image sensors or similar to record the intensity of light as variable charges. In order to convert the content of the image sensor module of the camera module 237 to a digital signal, the ISP of the camera module 237 quantifies the variable charge into a discrete color value. A bitmap image contains pixel data quantified by the ISP in a given resolution such as 640×480, 1024×768 and so on. Each bitmap image may be further converted into a compressed format by the codec module 236 such as a Joint Photographic Experts Group (JPEG) encoder, a Graphics Interchange Format (GIF) encoder or similar to generate a compressed image such as a JPEG, GIF image or similar. The captured series of bitmap images may be encoded by a Moving Pictures Experts Group-4 (MP4) encoder or similar to generate a series of encoded frames such as I-, P- and B-frames. The generated live images such as bitmap, JPEG, GIF images, I-, P-, B-frames or others, can be continuously and serially transmitted to the computer host 21 (FIG. 2) via the connection module 235 such as a Bluetooth communication unit, an IrDA transmitter, a USB communication unit, or similar. Also, the live images can be transmitted to a remote mobile station via a wireless network.

The MCU 233 acquires live images from the camera module 237 or codec module 236 and transmits the acquired live images to the computer host 21 via the connection module 235. The storage module 234 provides nonvolatile storage for at least one “in-call” image. After receiving an incoming call request, the MCU 233 suspends the camera module 237 in order to suspend capture and transmission of live images, acquire the in-call image from the storage module 234 and subsequently transmits the acquired in-call image to the computer host via the connection device 235. The in-call image indicates the reception of the incoming call request by the mobile phone 23. After receiving a termination signal indicating that the communication for the incoming call request is terminated, the MCU 233 stops transmission of the in-call image and resumes transmissions of live images acquired by the camera module 237 to the computer host 21 via the connection device 235.

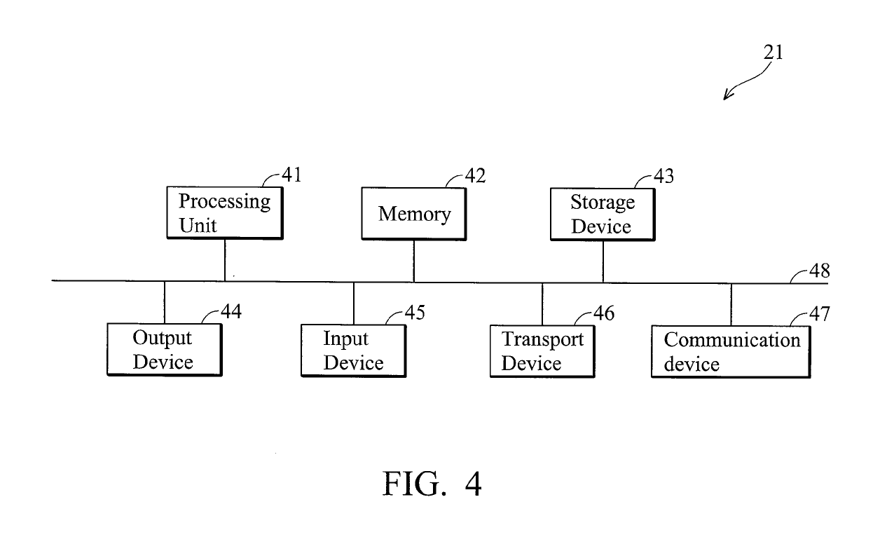

FIG. 4 is a diagram of a hardware environment applicable to an embodiment of the computer host 21 (FIG. 2), comprising a processing unit 41, a memory 42, a storage device 43, an output device 44, an input device 45, a transport device 46 and a communication device 47. The processing unit 41 is connected by buses 48 to the memory 42, storage device 43, output device 44, input device 45, transport device 46 and communication device 47 based on Von Neumann architecture. Generally, program modules include routines, programs, objects, components, scripts, Web pages, or others, that perform particular tasks or implement particular abstract data types. The storage device 43 may be a flash memory, a memory card, a hard drive, magnetic drive, optical drive, portable drive, or nonvolatile memory drive. The storage device 43 provides nonvolatile storage for computer-readable instructions, data structures and program modules. The transport device 46 coupling to the base 29 (FIG. 2) may be the described serial port, parallel port or wireless transmitter and receiver. The communication device 47 such as an Ethernet adapter, wireless communication adapter, asymmetric digital subscriber line (ADSL) modem or similar connects to an Internet Protocol (IP) network.

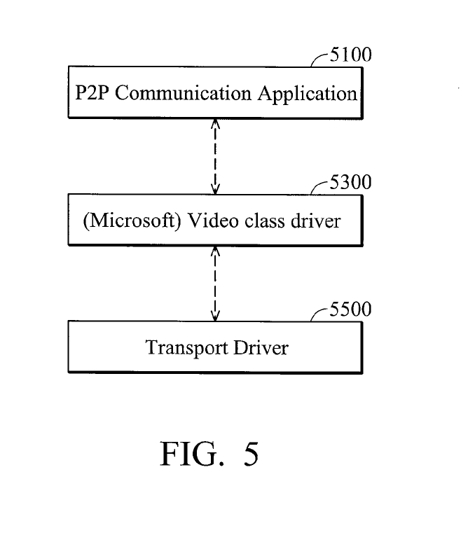

FIG. 5 is a diagram of the software architecture of an embodiment of program modules executed by the processing unit 41 of the computer host 21 (FIG. 4). A P2P communication application 5100 receives live images or in-call images from the mobile phone 23 (FIG. 2) through the Video class driver 5300, and a transport driver 5500. The P2P communication application 5100 continuously transmits the received live images or in-call images to a corresponding P2P communication application resident on a remote computer host.

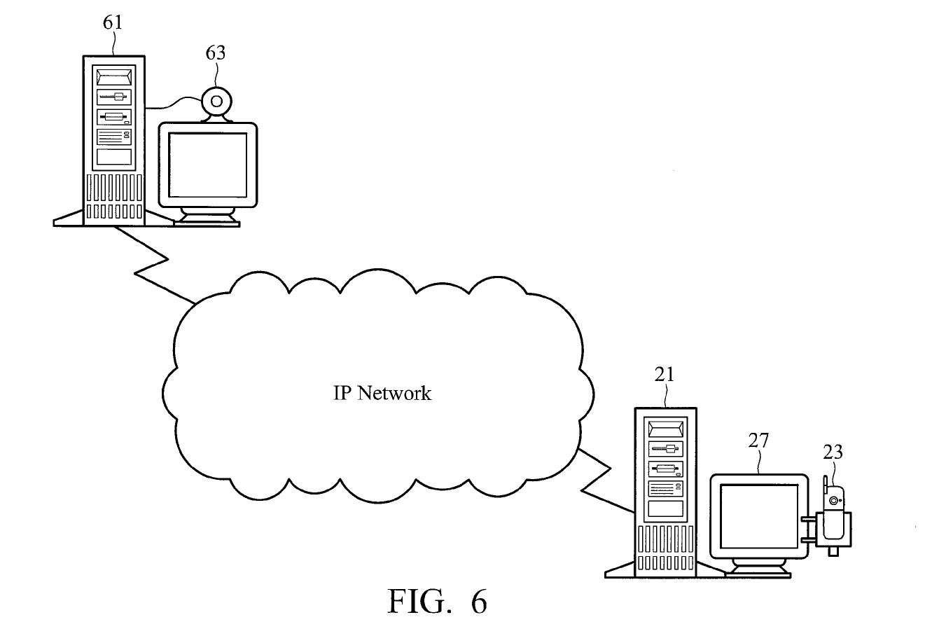

FIG. 6 is a diagram of data communication between two parties through an IP network. A peer-to-peer (P2P) communication application resident on the computer host 21, such as Microsoft MSN Messenger, Yahoo! Messenger, Skype or similar, acquires live images from the coupled mobile electronic device 23 and transmits the acquired live images to another P2P communication application resident on a remote electronic apparatus/device 61 such as a personal computer, mobile phone, portable media player (PMP), PDA or similar, connected to an internet protocol (IP) network such as a local area network (LAN), wireless LAN, Internet or similar. The remote electronic apparatus/device 61 equipped with a webcam 63 continuously acquires live images corresponding to a remote user facing to the webcam 63 to the P2P communication application resident on the computer host 21 through the IP network.

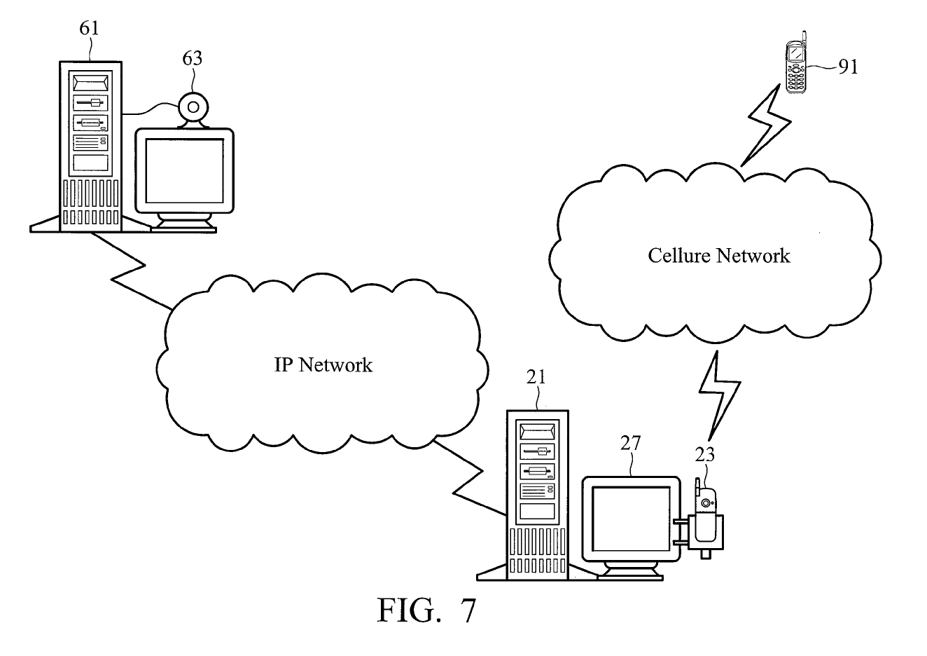

FIG. 7 is a diagram of data communication among the three parties through an IP network and a cellular network. A P2P communication application resident on the computer host 21, such as Microsoft MSN Messenger, Yahoo! Messenger, Skype or similar, acquires live images via the coupled mobile electronic device 23 and transmits the acquired live images to another P2P communication application resident on a remote electronic apparatus/device 61 such as a personal computer, mobile phone, PMP, PDA or similar, connecting to an IP network such as a local area network (LAN), wireless LAN, Internet or similar. When the mobile electronic device 23 operates as a webcam, the mobile electronic device 23 may simultaneously receive incoming call requests from a remote mobile electronic device 91 via a cellular network such as global system for mobile communications (GSM), enhanced data rates for global evolution (EDGE), code division multiple access (CDMA) network or similar.

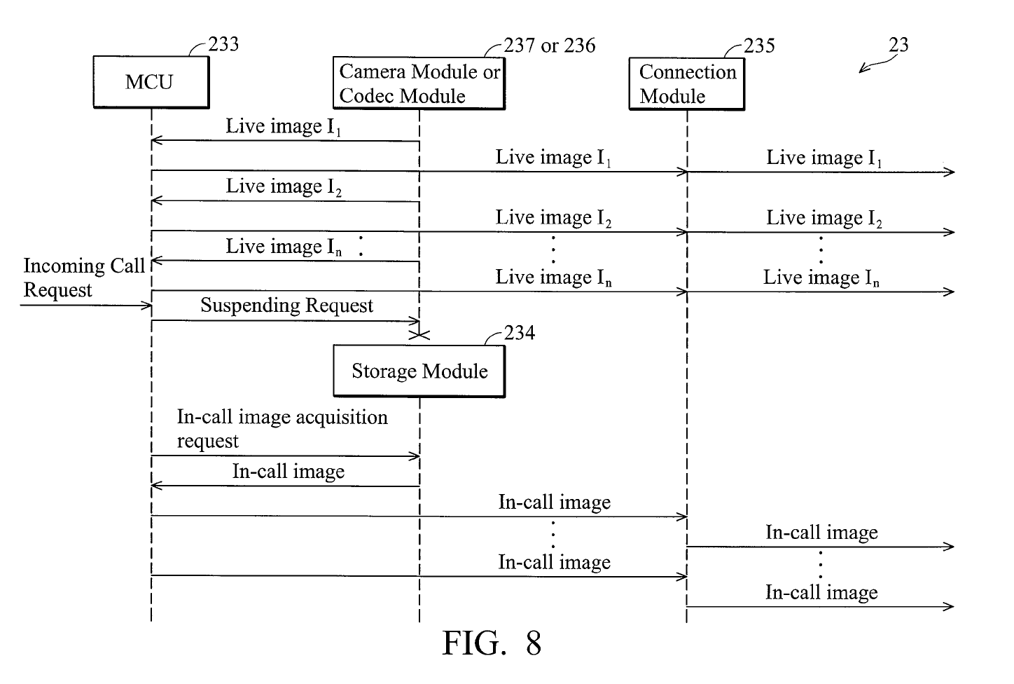

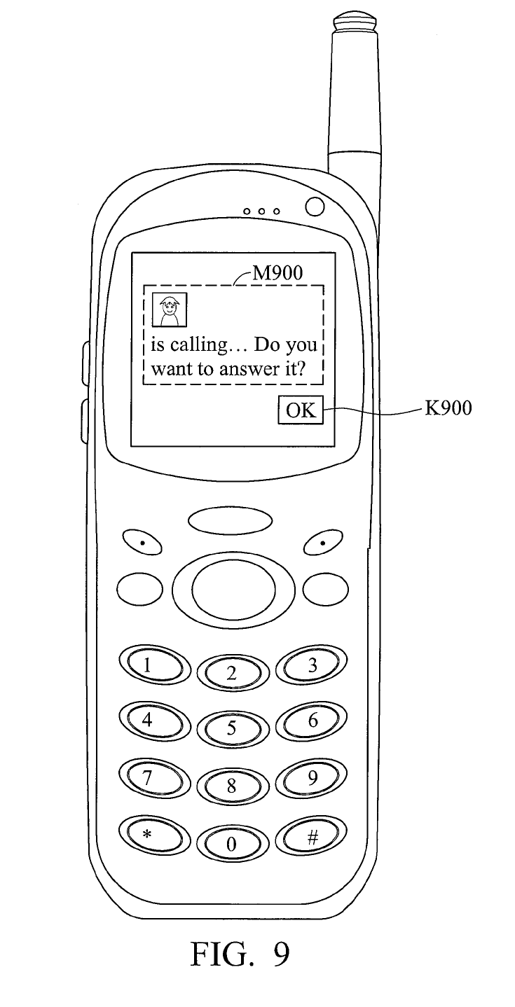

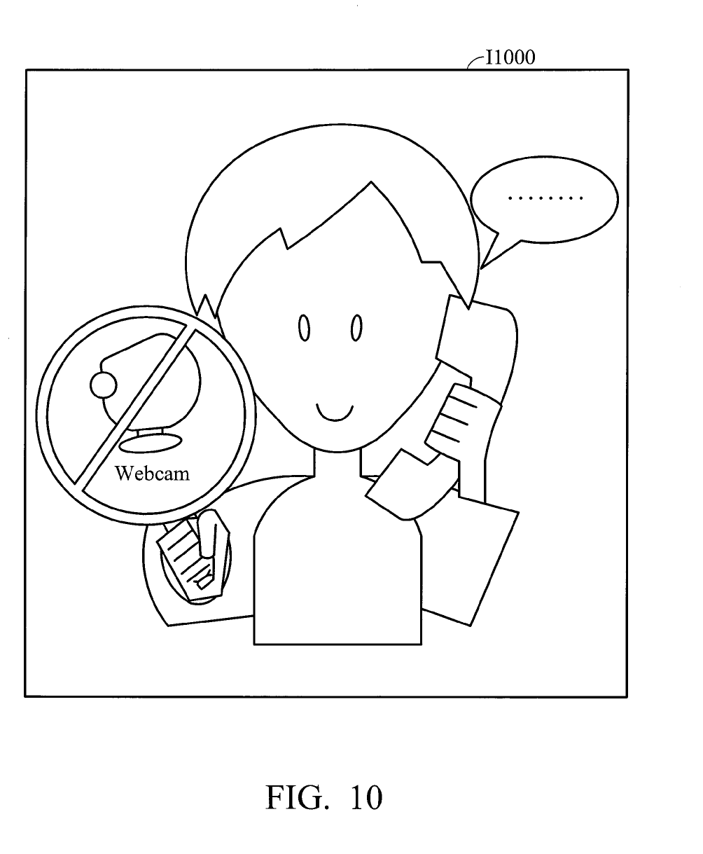

FIG. 8 is a sequence diagram showing suspension of transmission of live images captured by the camera module 237 and transmission of an in-call image acquired by the storage module 234. When the mobile phone 23 couples to the computer host 21 (FIG. 7) and operates as a Webcam, the MCU 233 serially acquires live images I1, I2 to In from the camera module 237 or the codec module 236 and transmits the acquired live images I1, I2 to In to the computer host 21 via the connection module 235, enabling transmission of live images to the remote electronic apparatus/device 61 (FIG. 7). When receiving an incoming call request via the transceiver module 232 (FIG. 3) from the remote mobile electronic device 91 (FIG. 9), the MCU 233 may instantly issue a suspension signal to the camera module 237 and subsequently the camera module 237 suspends capture of live images. In some embodiments, when receiving an incoming call request via the transceiver module 232 from the remote mobile electronic device 91, the MCU 233 may display a query on a screen thereof for prompting a user to answer the received incoming call request or not. FIG. 9 is a diagram of an embodiment of a query for prompting a user to answer the detected incoming call request or not, by displaying a prompt message M900 and a soft key K900. When detecting that a hard key corresponding to the soft key K900 on a keypad thereof is pressed (i.e. a user decides to answer the received incoming call request), the MCU 233 issues a suspension signal to the camera module 237 and subsequently the camera module 237 suspends capture of live images. Note that, after answering the incoming call request, the mobile phone 21 communicates with the remote mobile electronic device 91 (FIG. 7) via a cellular network. After suspending the camera module 237, the MCU 233 acquires at least one in-call image by issuing an in-call image acquisition request to the storage module 234, and repeatedly transmits the acquired in-call image to the computer host 21 via the connection module 235, enabling transmission of an in-call image to the remote electronic apparatus/device 61 via the Internet. The remote electronic apparatus/device 61 will display the received in-call image on a screen thereof to notify a remote user of the reception of an incoming call request by the mobile phone 23. FIG. 10 is a diagram of an embodiment of an in-call image I1000. Those skilled in the art will realize that two or more different in-call images can be sequentially acquired and transmitted to the computer host 21 and then to the remote electronic apparatus/device 61, thus, the remote electronic apparatus/device 61 can display an animation or a video streaming by displaying the sequentially-received in-call images.

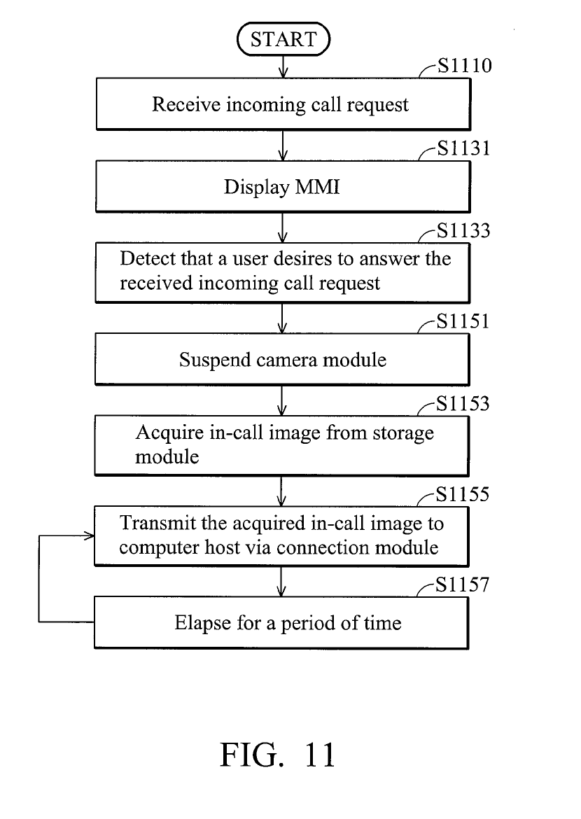

FIG. 11 is a flowchart of an embodiment of a method for transmitting images to the computer host 21 (FIG. 7), performed by the MCU 233 (FIG. 2) of the mobile phone 23 (FIG. 7), when an incoming call request is received. In step S1110, an incoming call request is received from the remote mobile electronic device 91 (FIG. 7). In step S1131, an MMI (as shown in FIG. 9) is displayed for prompting a user to answer the received incoming call request or not. In step S1133, that a user decides to answer the received incoming call request is detected via the displayed MMI. In step S1151, the camera module 237 (FIG. 2) is suspended, thereby suspending capture of live images. In step S1153, an in-call image (e.g. I1000 of FIG. 10) is acquired from the storage module 234 (FIG. 2). In step S1155, the acquired in-call image is transmitted to the computer host 21 via the connection module 235 (FIG. 2). After a period of time has elapsed, as shown in step S1157, the process proceeds to step S1155 to re-transmit the in-call image. Note that the steps S1131 and S1133 may be omitted to increase performance.

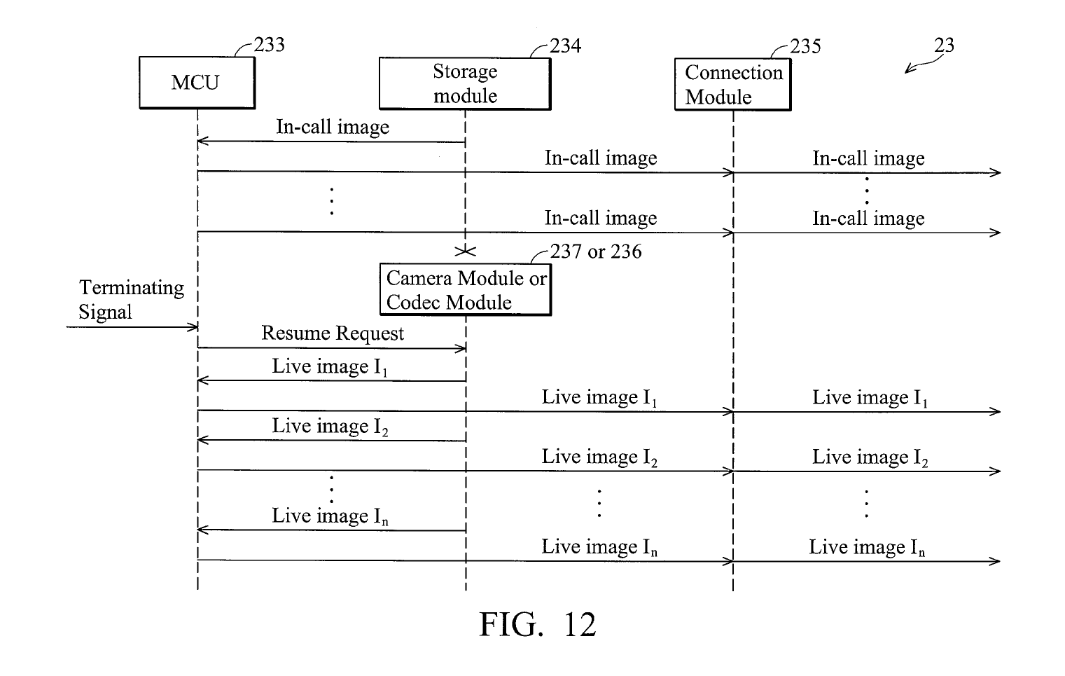

FIG. 12 is a diagram of a sequence diagram for resuming the suspended transmissions of live images captured by the camera module 237. When the mobile phone 23 communicates with a remote mobile electronic device 91 (FIG. 7), the MCU 233 acquires an in-call image from the storage module 234 and transmits the acquired in-call image to the computer host 21 via the connection module 235, enabling transmission of in-call image to the remote electronic apparatus/device 61 via the internet (FIG. 7). When receiving a termination signal indicating the communication between the mobile phone 23 and the remote mobile electronic device 91 is terminated, the MCU 233 instantly stops transmission of the in-call image to the computer host 21 and issues a resume request to the camera module 237, and subsequently the camera module 237 resumes the previously suspended capture of live images. After resuming the camera module 237, the MCU 233 serially acquires live images I1, I2 to In from the camera module 237 or the codec module 236 and transmits the acquired live images I1, I2 to In to the computer host 21 via the connection module 235, enabling transmissions of live images to the remote electronic apparatus/device 61 (FIG. 7) via the Internet. The remote electronic apparatus/device 61 will display the received live images on a screen thereof.

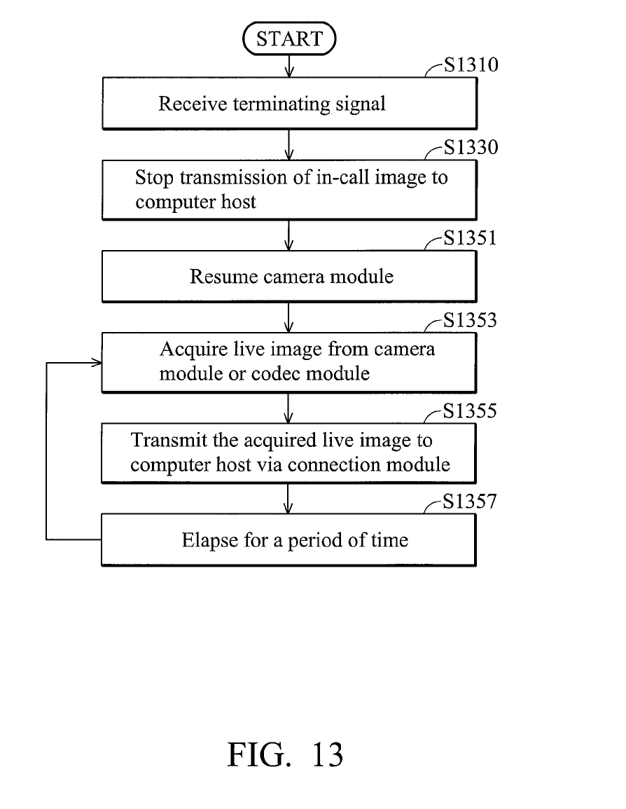

FIG. 13 is a flowchart of an embodiment of a method for transmitting images to the computer host 21 (FIG. 7), performed by the MCU 233 (FIG. 2) of the mobile phone 23 (FIG. 7), when a termination signal is received. In step S1310, a termination signal indicating the communication between the mobile phone 23 and the remote mobile electronic device 91 (FIG. 7) is terminated. In step S1330, transmission of an in-call image (e.g. I1000 of FIG. 10) to the computer host 21 is stopped. In step s1351, the camera module 237 (FIG. 2) is resumed, thereby resuming the previously suspended capture of live images. In step S1353, a live image is acquired from the camera module 237 or the codec module 236 (FIG. 2). In step S1355, the acquired live image is transmitted to the computer host 21 via the connection module 235 (FIG. 2). After a period of time is elapsed as shown in step S1357, the process proceeds to step S1353 to acquire the next live image.

Methods for image transmission, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD recorder or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

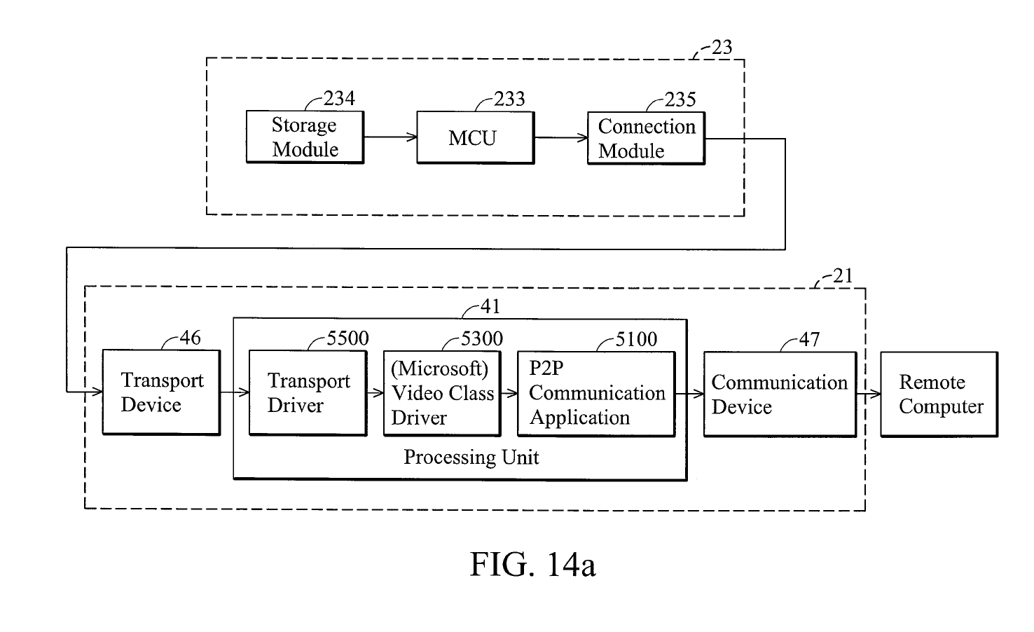

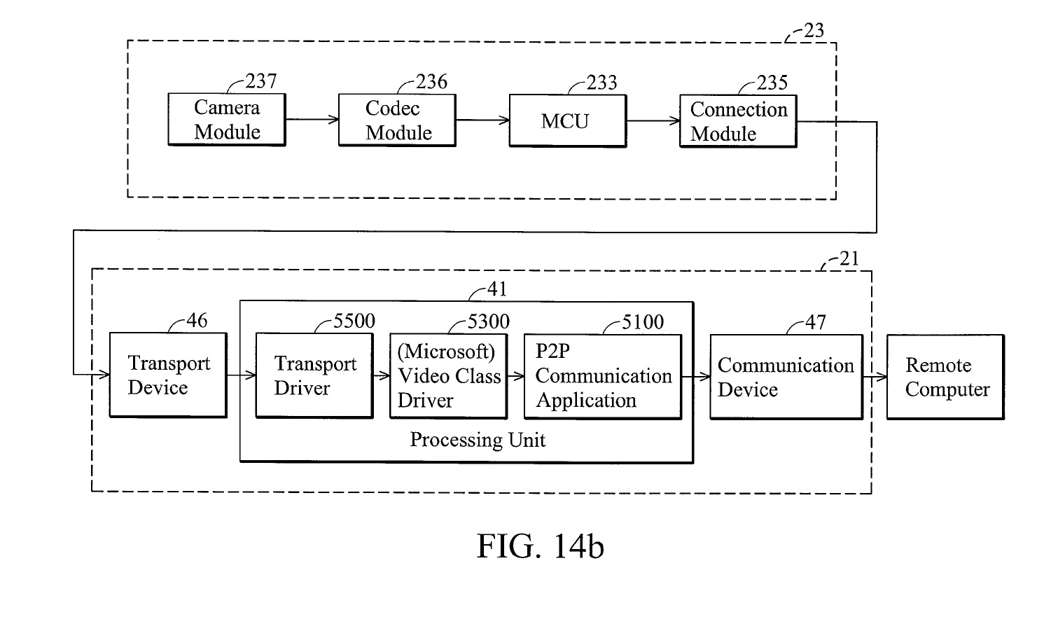

FIG. 14a is a diagram of an embodiment of a pipeline for transmitting in-call images from the mobile electronic device 23 (FIG. 2) to the computer host 21 (FIG. 2). The MCU 233 acquires in-call images from the storage module 234 and transmits the in-call images to the transport device 46 of the computer host 21 (FIG. 4) via the connection module 235. Thereafter, the P2P communication Application 5100 executed by the processing unit 41 acquires the in-call images from the transport device 46 via the transport driver 5500 and video class driver 5300 executed by the processing unit 41, and transmits the in-call images to a remote computer via the communication device 47.

FIG. 14b is a diagram of an embodiment of a pipeline for transmitting live images from the mobile electronic device 23 (FIG. 2) to the computer host 21 (FIG. 2). A series of live images are continuously generated through the camera module 237 and codec module 236 (or only the camera module 237). An image signal processor of the camera module 237 may blend content such as text, symbols, graphic patterns into raw images detected by an image sensor module thereof or adjust image parameters of the raw images, such as color temperature, contrast or similar, to generate live images. The generated raw images are encoded in a particular format by the codec module 236, which may be a JPEG encoder, MP4 encoder or GIF encoder to generate a series of live images, which may be JPEG, GIF images, I-, P-, B-frames. The JPEG encoder, MP4 encoder or GIF encoder may merge textual data or image data into each raw image and encode the merged images to generate live images. For example, textual data corresponding to a nickname of a user may be merged into raw images, enabling a remote computer to display the generated live images with the nickname. The MCU 233 sequentially transmits the generated live images to the transport device 46 via the connection module 235. Thereafter, the P2P communication Application 5100 executed by the processing unit 41 acquires the live images from the transport device 46 via the transport driver 5500 and video class driver 5300 executed by the processing unit 41, and transmits the live images to a remote computer via the communication device 47.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for image transmission performed by a mobile electronic device, the mobile electronic device sequentially transmitting a plurality of live images captured by a camera module thereof to a computer host for further transmitting the live images to a remote electronic device, the method comprising:
receiving an incoming call request from a remote mobile electronic device;
suspending transmission of the live images after receiving the incoming call request; and
transmitting at least one in-call image indicating the reception of the incoming call request to the computer host for further transmitting the at least one in-call image to the remote electronic device.

2. The method as claimed in claim 1 further comprising:
prompting a user to answer the received incoming call request or not after receiving the incoming call request;
detecting that the user decides to answer the received incoming call request;
suspending transmission of the live images after detecting that the user decides to answer the received incoming call request; and
transmitting the at least one in-call image to the computer host.

3. The method as claimed in claim 2 further comprising:
issuing a suspension signal to the camera module of the mobile electronic device to suspend capture of the live images after detecting that the user decides to answer the received incoming call request; and
issuing an in-call image acquisition request to a storage module to acquire the at least one in-call image after detecting that the user decides to answer the received incoming call request.

4. The method as claimed in claim 2 further comprising communicating with the remote mobile electronic device after detecting that the user decides to answer the received incoming call request.

5. The method as claimed in claim 4 further comprising:
receiving a termination signal indicating the communication between the mobile electronic device and the remote mobile electronic device is terminated;
suspending transmission of the at least one in-call image to the computer host after receiving the termination signal; and
resuming transmission of live images sequentially captured by the camera module thereof to the computer host after receiving the termination signal, wherein the computer host further sequentially transmits the live images to the remote electronic device.

6. The method as claimed in claim 5 further comprising issuing a resume request to the camera module thereof to resume capture of live images.

7. The method as claimed in claim 1 further comprising:
issuing a suspension signal to the camera module thereof to suspend capture of the live images after receiving the incoming call request; and
issuing an in-call image acquisition request to a storage module to acquire the at least one in-call image after receiving the incoming call request.

8. The method as claimed in claim 1 wherein the mobile electronic device is configured as a Web camera of the computer host when capturing and transmitting the live images to the computer host.

9. The method as claimed in claim 1 wherein the mobile electronic device and the remote mobile electronic device connect to a cellular network, and the computer host and the remote electronic apparatus/device connect to an Internet Protocol (IP) network.

10. The method as claimed in claim 1 wherein the live images and the at least one in-call image are transmitted to the remote electronic apparatus/device via a peer-to-peer (P2P) communication application resident on the computer host.

11. A system for image transmission installed in a mobile electronic device, the mobile electronic device sequentially transmitting a plurality of live images to a computer host for further transmitting the live images to a remote electronic device, the system comprising:
a transceiver module;
a connection module coupling to the computer host; and
a micro-control unit (MCU) receiving an incoming call request from a remote mobile electronic device via the transceiver module, suspending transmission of the live images after receiving the incoming call request, and transmitting at least one in-call image indicating the reception of the incoming call request via the connection module to the computer host for further transmitting the at least one in-call image to the remote electronic device.

12. The system as claimed in claim 11 further comprising a display, wherein the MCU prompting a user to answer the received incoming call request or not after receiving the incoming call request, detects that the user decides to answer the received incoming call request, suspends transmission of the live images after detecting that the user decides to answer the received incoming call request, and transmits the at least one in-call image to the computer host.

13. The system as claimed in claim 12 further comprising a camera module and a storage module, wherein the MCU further issues a suspension signal to the camera module to suspend capture of the live images after detecting that the user decides to answer the received incoming call request, and issues an in-call image acquisition request to the storage module to acquire the at least one in-call image after detecting that the user decides to answer the received incoming call request.

14. The system as claimed in claim 12 wherein the MCU communicates with the remote mobile electronic device via the transceiver module after detecting that the user decides to answer the received incoming call request.

15. The system as claimed in claim 14 wherein the MCU receives a termination signal indicating the communication between the mobile electronic device and the remote mobile electronic device is terminated, suspends transmission of the at least one in-call image to the computer host after receiving the termination signal, and resumes transmission of live images sequentially captured by the camera module thereof to the computer host after receiving the termination signal, and the computer host further sequentially transmits the live images to the remote electronic-device.

16. The system as claimed in claim 15 wherein the MCU issues a resume request to the camera module to resume capture of live images.

17. The system as claimed in claim 11 further comprising a camera module and a storage module, wherein the MCU issues a suspension signal to the camera module thereof to suspend capture of the live images after receiving the incoming call request, and issues an in-call image acquisition request to the storage module to acquire the at least one in-call image after receiving the incoming call request.

18. The system as claimed in claim 11 wherein the mobile electronic device is configured as a Web camera of the computer host when capturing and transmitting the live images to the computer host.

19. The system as claimed in claim 16 wherein the mobile electronic device and the remote mobile electronic device connect to a cellular network, and the computer host and the remote electronic apparatus/device connect to an Internet Protocol (IP) network.

20. The system as claimed in claim 11 wherein the live images and the at least one in-call image are transmitted to the remote electronic apparatus/device via a peer-to-peer (P2P) communication application resident on the computer host.
